(19) United States
(12) Patent Application Publication
(10) Pub. No.: US 2011/0029964 A1
(43) Pub. Date: Feb. 3, 2011

(54) METHOD AND SYSTEM FOR UPDATING PROGRAMS IN A MULTI-CLUSTER SYSTEM

(75) Inventors: Hiroki Kobayashi, Kawasaki (JP); Yoichi Tanimura, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/845,430

(22) Filed: Jul. 28, 2010

(30) Foreign Application Priority Data
Jul. 31, 2009 (JP) 2009-178623

(51) Int. Cl. G06F 9/44

(52) U.S. Cl. 717/171

(57) ABSTRACT

A multi-cluster system including a plurality of clusters that execute a program, the plurality of clusters are configured to receive a patch from a monitoring center to update the program, a system storage unit that is connected to the plurality of clusters via a first network, and an add-on cluster to be added on to the multi-cluster system is connected to the first network, the add-on cluster receives, from the system storage unit, a version number management table and a program version number of an in-operation program in the plurality of clusters, requests the monitoring center to distribute a patch of the version number of the in-operation program in the plurality of clusters, receives the requested patch and updates the program that has been installed into the add-on cluster.

### CROSS-REFERENCE TO RELATED APPLICATION

This application is based upon and claims the benefit of priority of the prior Japanese Patent Application No. 2009-178623, filed on Jul. 31, 2009, the entire contents of which are incorporated herein by reference.

### FIELD

The embodiments discussed herein are related to a system and method of updating programs when clusters are to be added on in a multi-cluster system.

### BACKGROUND

In main frame systems, multi-cluster systems have been widely used. Normally, multi-cluster systems include a plurality of clusters, a system storage unit, and a service processor manager (hereinafter referred to as an “SVPM”).

In such multi-cluster systems, in order to stably operate the system, correction of programs (called “patching”) of each cluster (computer) and each system storage unit is performed. In order for a program to be automatically corrected without stopping the entire system, it has been proposed that the clusters are connected to a remote monitoring center (see, for example, Japanese Laid-open Patent Publication No. 2006-40188).

As a consequence of the correction of a program, when the clusters are to be operated as a multi-cluster system, if the program version numbers of individual computers do not match each other, an operation error occurs. For this reason, confirmation of the compatibility of the program version numbers is performed.

FIG. 22 is an illustration of the related art. In FIG. 22, as an example, a multi-cluster system 100 includes two clusters 106 and 108, system storage units 102 and 104, and a service processor manager 101.

In the example of FIG. 22, the system storage unit (hereinafter also referred to as an SSU) 102 manages the version numbers of programs, here, a hardware control program (HCP). The program version number of each of the clusters 106 and 108 and the SSUs 102 and 104 is a version number that can be incorporated in a system storage unit (hereinafter referred to as a “master SSU-SVP”) 102.

Each of the clusters 106 and 108, and the SSUs 102 and 104 has a version number management table file in which combinations of the up-to-date version number information on an HCP and version number information with which the clusters can be operated as a multi-cluster system are registered. The multi-cluster system 100 of FIG. 22 has a management table B, in which, as the up-to-date version number information on the HCP, the version number: E60L02G-02B+8 of the cluster, and the version number: E16L02S-02B+8 of the SSU are stored.

Then, in the SSUs 106 and 104, the version number of an HCP in operating condition (herein after referred to as “operation system HCP”) is “E16L02S-02A+5”, and the version number of a HCP in standby condition (herein after referred to as “standby system HCP”) is “E16L02S-02B+8”. Furthermore, in the clusters 106 and 108, the version number of the operation system HCP is “E60L02G-02A+5”, and the version number of the standby system HCP is “E60L02G-02B+8”.

When the cluster is to be started, the master SSU-SVP 102 checks the data of the combination of the operation system and the standby system against the version number information in the HCP of each of the clusters 106 and 108, and the SSU 104, which is registered in the version number management table, and confirms whether or not the version number of the HCP of each of the clusters 106 and 108, and the SSU 104 is a version number that can be incorporated in the system. This is referred to as a version number compatibility confirmation.

Then, a cluster and an SSU, in which a pattern that can be incorporated in the master SSU-SVP has been registered, are not incorporated in the system causing the startup of the cluster and the SSU to fail.

Additionally, an update (patch update) of the clusters 106 and 108 and the SSUs 102 and 104 is performed at the time of a periodic connection to a remote monitoring center (as an example, two hours after the startup, and thereafter, every four hours).

When the periodic connection to the remote monitoring center 120 is made, the service processor manager 101 receives a version number management table file from the remote monitoring center 120 and distributes it to the master SSU-SVP 102. Then, the master SSU-SVP 102 distributes a patch to each of the clusters 106 and 108 and the SSU 104. The master SSU-SVP 102 performs a version number compatibility confirmation, for example, two hours after the startup of the system and four hours thereafter.

The HCP includes an operation system HCP that is used during operation, and a standby-system HCP that receives a patch at the time of an update. In the version number compatibility confirmation performed by the master SSU-SVP 102, the confirmation of the compatibility of the version number of the standby system HCP is performed. When the version number of the standby-system HCP is older than the HCP version number registered in the version number management table file of the master SSU-SVP 102, the master SSU-SVP 102 instructs the cluster and the SSU to receive an up-to-date patch from the remote monitoring center 120.

After the patch is received from the remote monitoring center 120, the system is made to operate in the state of the up-to-date HCP by switching the standby-system HCP to the operation system HCP with a CE (Customer Engineer) operation.

As illustrated in FIG. 22, in an example in which a cluster 110 is to be newly added on in this multi-cluster system, the program version number of the add-on cluster 110 is “E60L02G-01R+2” for the operation system and is “E60L02G-01R+2” for the standby system. For this reason, since the program version number of the add-on cluster 110 differs from the program version number of the existing clusters and SSUs (“E60L02G-02A+5” for the operation system and “E60L02G-02R+8” for the standby system), in a state as is, the add-on cluster 110 is not incorporated in the multi-cluster system.

On the other hand, a method of porting setting data from another cluster with respect to such an add on of a cluster has already been proposed (for example, Japanese Laid-open Patent Publication No. 2006-40188).

However, the updating of a program receives a larger amount of data unlike the setting information. In a method of simply porting a program from another cluster, updating the program of the add-on cluster during the system operation takes much time and is a hindrance to the operation system, which is undesirable.

Furthermore, when a cluster is to be added on in the system in which a patch is transmitted from the remote center of FIG. 22, as illustrated in FIG. 23, the master SSU-SVP 102 that manages the version number finds a cluster/SSU having a version number management table older than the version number management table B possessed by the cluster/SSU, the master SSU-SVP 102 then distributes the up-to-date management table. At this time, it is confirmed that the version number management table of the add-on cluster 110 is a version number management table A, and the version number management table does not match the version number management tables of the other clusters.

As illustrated in FIG. 24, the add-on cluster 110 that obtained the up-to-date management table B requests the remote monitoring center 120 for a patch so that the version number of the HCP of the add-on cluster becomes the up-to-date version number of the HCP in accordance with the information of the version number management table B via the service processor manager 101. The remote monitoring center 120 distributes the requested patch. The add-on cluster 110 receives the patch from the remote monitoring center 120. That is, the HCP of the standby system is updated to the up-to-date version number “E60L02G-02B+8”.

As a result of the distribution of the up-to-date patch of FIG. 24, the HCP of the standby system of the add-on cluster is also updated to the up-to-date version number “E60L02G-02B+8”, however, the version numbers of the HCPs of the operation systems of the other clusters are “E60L02G-02A+5”.

Then, as illustrated in FIG. 25, as a result of a CE operation, the standby-system HCP of the add-on cluster 110 is switched to an operation system HCP. As described in FIG. 24, the HCP version number of the standby system of the add-on cluster 110 is the up-to-date HCP version number registered in the management table B. Thus, the HCP version number of the standby system becomes different from the version numbers of the other clusters during operation.

As illustrated in FIG. 26, even if the add-on cluster is started using the up-to-date HCP version number with the CE operation, the version number does not match those of the other clusters, and the cluster is not incorporated into the system. For this reason, although an online instruction of the add-on cluster 110 is made to the service processor manager 101, since the add-on cluster 110 is not incorporated in the system, an online instruction to the add-on cluster 110 is not made.

As described above, when the version number of the HCP installed into the add-on cluster is not up-to-date and the HCP version number of the existing system is not up-to-date (for example, a case in which the add-on cluster has already been purchased, but has not been added on immediately), the update from the remote monitoring center allows only the HCP installed into the add-on cluster to be up-to-date, and an incompatible state is reached.

In order to switch the entire system to the up-to-date HCP state, the system is stopped. However, this is inconvenient because this causes the business of the customer to be interrupted.

Furthermore, the following problem arises. As a result of the periodic connection, the patch reception of each cluster is performed after a passage of four hours, and a match with the HCP version number of the add-on cluster is made. However, a CE operation in which an add-on operation is performed is awaited for a maximum of four hours, and the CE operation is not completed within the scheduled time period.

### SUMMARY

According to one example of the embodiments, a multi-cluster system including a plurality of clusters that execute a program, the plurality of clusters are configured to receive a patch from a monitoring center to update the program, a system storage unit that is connected to the plurality of clusters via a first network, and an add-on cluster to be added on to the multi-cluster system is connected to the first network, the add-on cluster receives, from the system storage unit, a version number management table and a program version number of an in-operation program in the plurality of clusters, requests the monitoring center to distribute a patch of the version number of the in-operation program in the plurality of clusters, receives the requested patch and updates the program that has been installed into the add-on cluster.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram according to an embodiment of a multi-cluster system of the present invention;

FIG. 2 is a block diagram of a cluster of FIG. 1;

FIG. 3 is a block diagram of a system storage unit of FIG. 1;

FIG. 4 is a program update sequence diagram of an add-on cluster according to a first embodiment;

FIG. 5 is an illustration of an HCP version number when a cluster is to be added on in FIG. 4;

FIG. 6 is an illustration of an HCP distribution request process of the add-on cluster of FIG. 4;

FIG. 7 is an illustration of a patch request process of the add-on cluster of FIG. 4;

FIG. 8 is an illustration of an HCP switching process of the add-on cluster of FIG. 4;

FIG. 9 is an illustration of a process for incorporating the add-on cluster in the system incorporation process of FIG. 4;

FIG. 10 is a program update sequence diagram of an add-on cluster according to a second embodiment;

FIG. 11 is an illustration of an HCP version number when a cluster is to be added on in FIG. 10;

FIG. 12 is an illustration of an HCP copy request process of the add-on cluster in FIG. 10;

FIG. 13 is an illustration of a logical volume copy request process of the add-on cluster in FIG. 10;

FIG. 14 is an illustration of a process for copying the requested cluster in FIG. 10;

FIG. 15 is an illustration of a process for notifying completion of the copying of the requested cluster in FIG. 10;

FIG. 16 is an illustration of a process for requesting copying of a logical volume next to the add-on cluster of FIG. 10;

FIG. 17 is an illustration of a process for copying the cluster for which the next logical volume is requested in FIG. 10;

FIG. 18 is an illustration of a process for notifying completion of the copying of the cluster for which the next logical volume is requested in FIG. 10;

FIG. 19 is an illustration of an HCP version number change process of the add-on cluster in FIG. 10;

FIG. 20 is an illustration of an HCP switching process of the add-on cluster of FIG. 10;

FIG. 21 is an illustration of a process for incorporating the add-on cluster in a system in FIG. 10;

FIG. 22 is an illustration of an HCP version number when a cluster is to be added on in the related art;

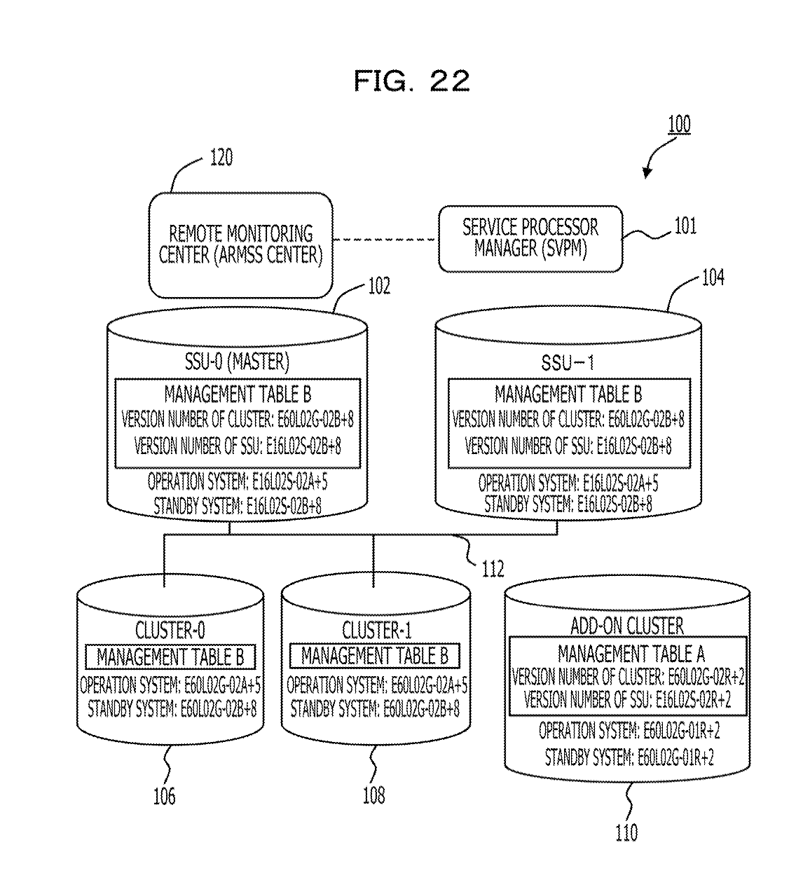

FIG. 23 is an illustration of an HCP compatibility confirmation process of an add-on cluster in the related art;

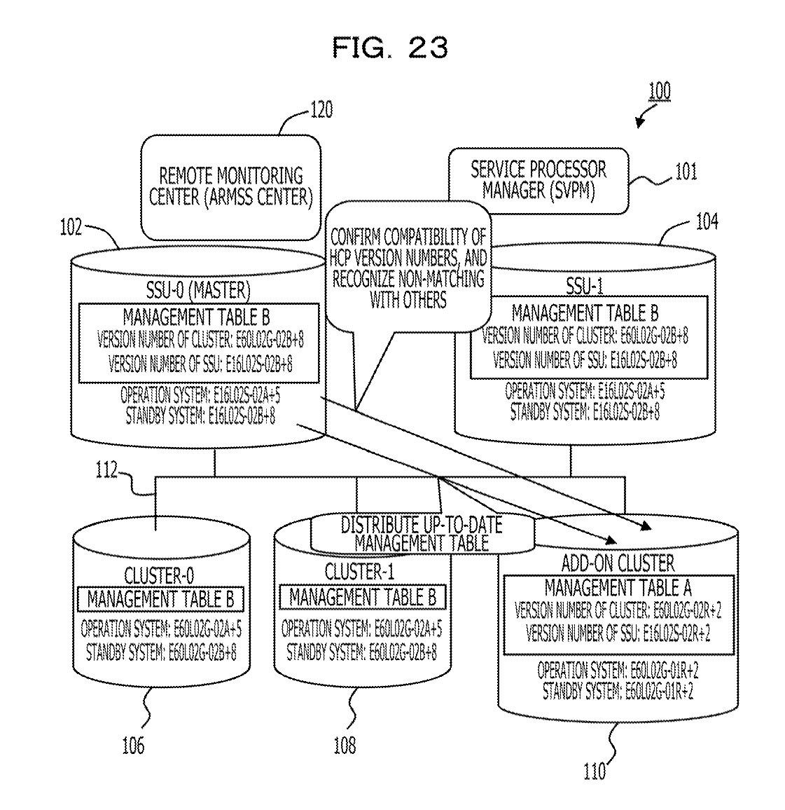

FIG. 24 is an illustration of a patch request process of an add-on cluster in the related art;

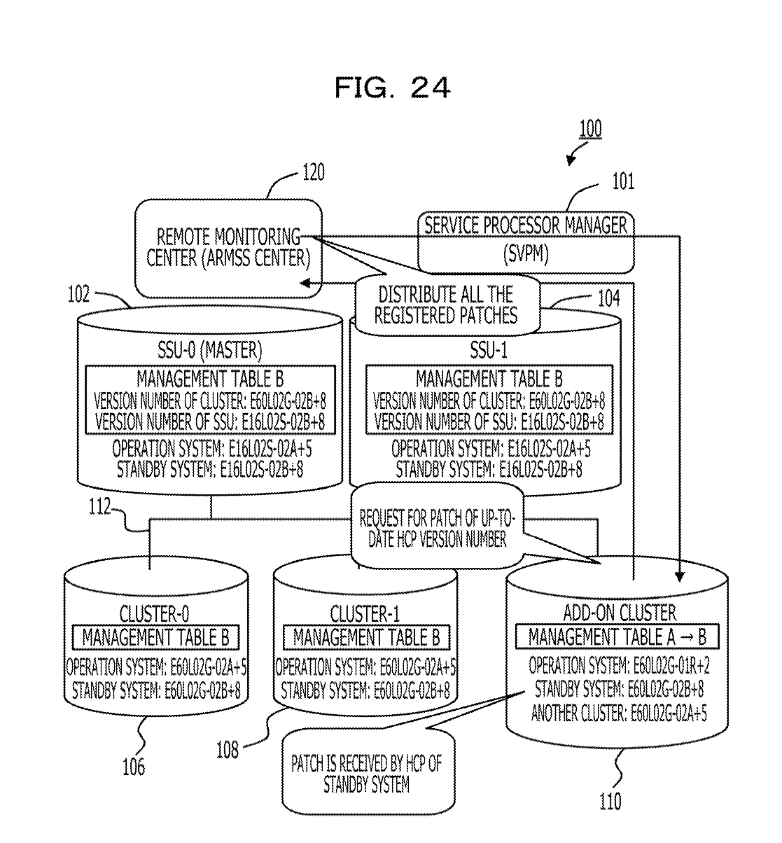

FIG. 25 is an illustration of an HCP switching process of an add-on cluster in the related art; and

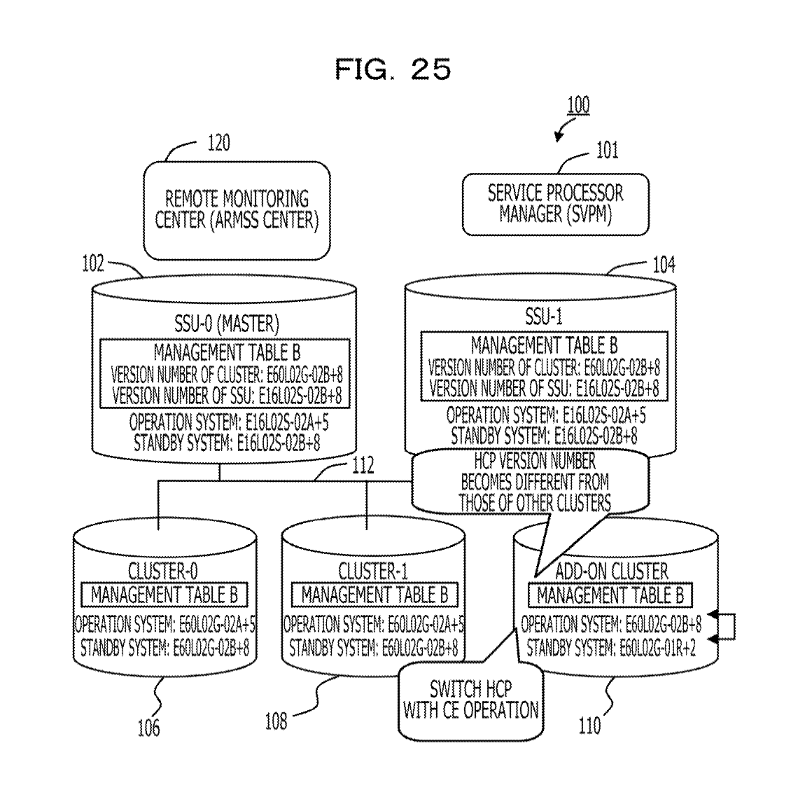

FIG. 26 is an illustration of a process for incorporating an add-on cluster in the system in the related art.

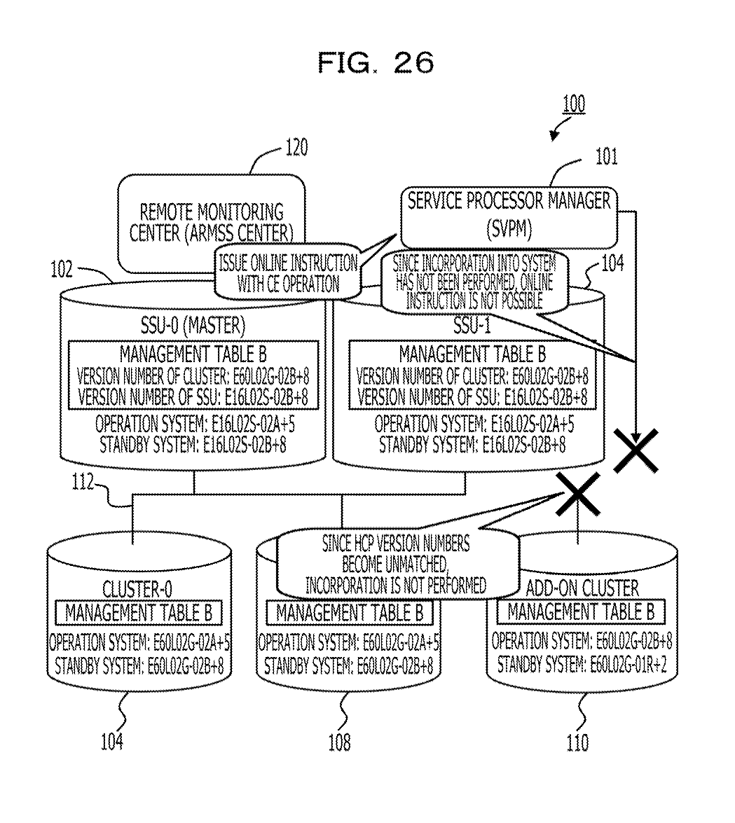

### DESCRIPTION OF EMBODIMENTS

It will be understood that when an element is referred to as being “connected to” another element, it may be directly connected or indirectly connected, i.e., intervening elements may also be present.

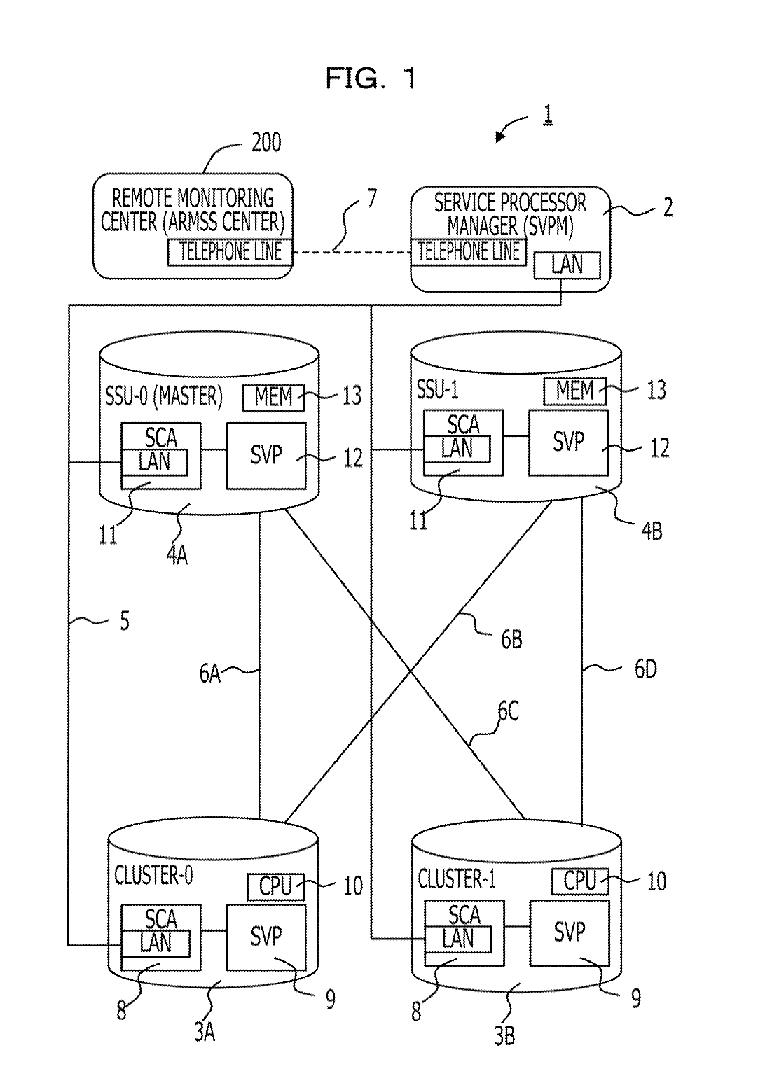

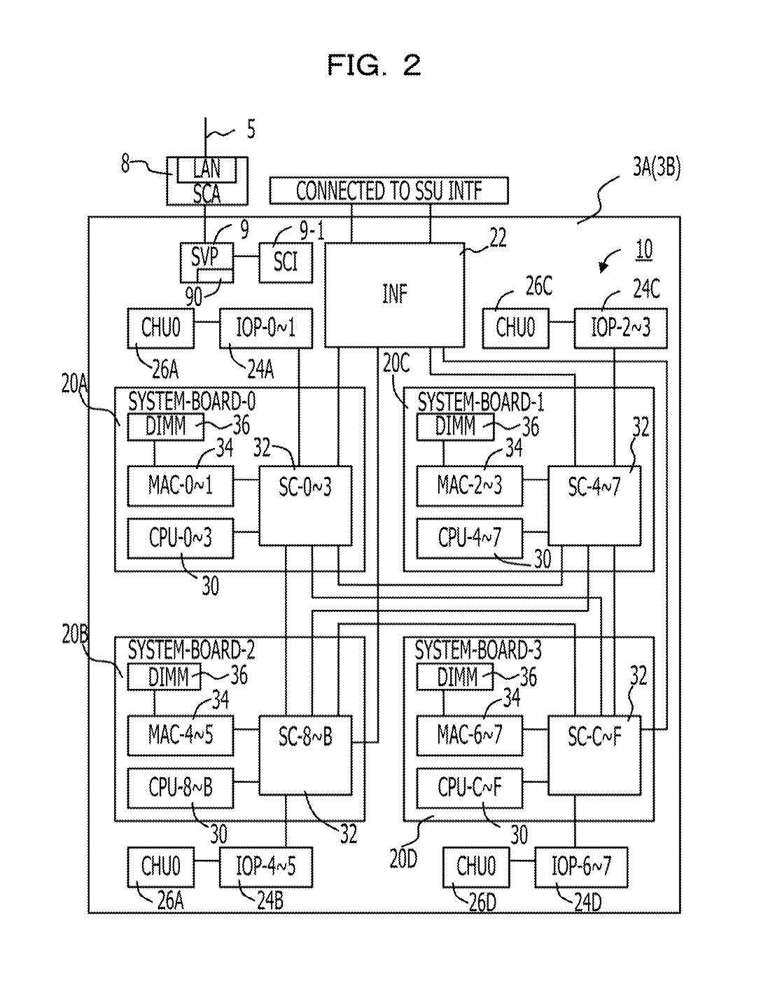

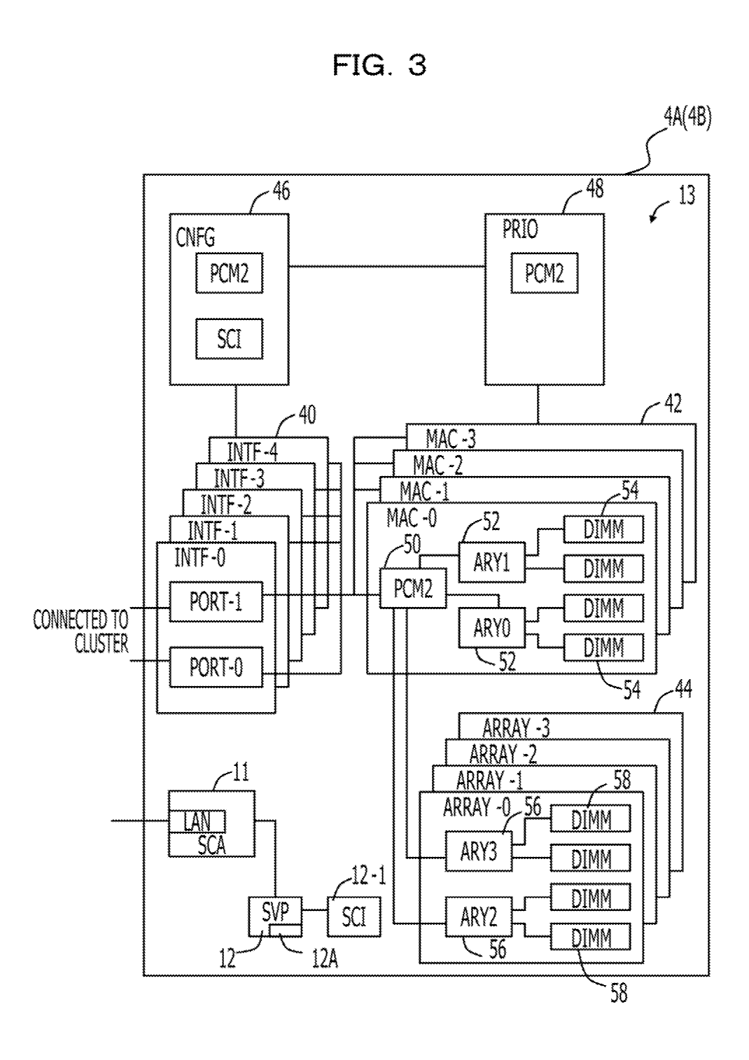

FIG. 1 is a configuration diagram according to an embodiment of a multi-cluster system 1. FIG. 2 is a block diagram of a cluster of FIG. 1. FIG. 3 is a block diagram of a system storage unit of FIG. 1. FIG. 1 illustrates, as an example, a multi-cluster system made up of two clusters 3A and 3B, two system storage units 4A and 4B, and a service processor manager 2.

The two clusters 3A and 3B are connected to system storage units 4A and 4B by connection lines 6A to 6D, respectively, read or write the data and the like to or from the system storage units 4A and 4B, and perform desired processing.

Clusters 3A and 3B include a CPU block 10 that performs desired data processing, a service processor (SVP) 9, and an SVP communication adaptor (SCA: an example of a communication device) 8 connected to the service processor 9.

Furthermore, the system storage units 4A and 4B include a memory block 13 for storing data, a service processor (SVP) 12, and an SVP communication adaptor (SCA) connected to the service processor 12.

SVP 9 of the clusters 3A and 3B, and SVP 12 of the system storage units (hereinafter referred to as “SSUs”) 4A and 4B are connected to one another via SCAs 8 and 11 through a local area network (LAN) 5. Furthermore, the SVP 9 of clusters 3A and 3B, and the SVP 12 of system storage units 4A and 4B are connected to service processor manager (SVPM) 2 via SCAs 8 and 11 through LAN 5. The network of LAN 5 is closed inside SVPM 2, the clusters 3A and 3B, and SSUs 4A and 4B.

SVPM 2 and a remote monitoring center 200 are connected to one another via a telephone line 7, and are remotely connected. On the other hand, clusters 3A and 3B, and SSUs 4A and 4B are not directly connected to an external network. In this example, multi-cluster system 1 is provided at the customer side. Remote monitoring center 200 is provided remotely from that of multi-cluster system 1, performs remote monitoring of a large number of multi-cluster systems 1, and as described above, transmits a version number management table file at the time of a periodic connection of service processor manager 2 to remote monitoring center 200.

In this example, the system storage unit (SSU) 4A manages a program (a hardware control program: HCP, for example) version number. The program version number of each of clusters 3A and 3B, and SSUs 4A and 4B needs to be a version number that can be incorporated in the system storage unit 4A (hereinafter referred to as a master SSU-SVP).

Referring to FIG. 2, clusters 3A and 3B are described. As illustrated in FIG. 2, each of clusters 3A and 3B includes a plurality (four, for example) of system boards 20A to 20D, an interface circuit 22 for making connection with SSUs 4A and 4B, I/O ports 24A to 24D for making connection with external peripheral devices, channels 26A to 26D, an SVP 9, and a system console interface circuit (SCI) 9-1 through which SVP 9 is connected to each of the internal circuits (system boards 20A to 20D, interface circuit 22, and I/O ports 24A to 24D, for example), the system console interface circuit (SCI) 9-1 being used to configure settings on the internal circuits.

Each of system boards 20A to 20D includes a CPU 30, a system controller (SC) 32, a memory access controller (MAC) 34, and an internal memory (DIMM) 36.

System controller 32 is connected to CPU 30, memory access controller 34, and I/O ports 24A to 24D. CPU 30 performs reading from and writing into memory 36, and performs desired processing. Furthermore, system controller 32 is connected to system controller 32 of another system board, and performs transmission and reception of data and commands with the system board. In addition, system controller 32 is connected to interface circuit 22, so that CPU 30 of each of system boards 20A to 20D transmits and receives commands and data with system storage units (SSU) 4A and 4B.

SVP 9 of FIG. 2 is connected to SCA 8 described with reference to FIG. 1 and is connected to LAN 5. SVP 9 has a version number management table 90 that includes HCPs, in which the version numbers of the operating-system HCP and the standby system HCP are stored. Furthermore, SVP 9 has a memory for storing the HCPs of the version numbers stored in version number management table 90. The HCP is firmware for controlling the hardware inside a cluster and performs resetting, setting, and the like of circuits inside system boards 20A to 20D, interface circuit 22, and I/O ports 24A to 24D.

A description is given below, with reference to FIG. 3, of SSUs 4A and 4B. As illustrated in FIG. 3, each of SSUs 4A and 4B includes a plurality (e.g., five) of interface circuits 40 that are connected to clusters 3A and 3B, a memory access controller (MAC) 42 connected to interface circuit 40, and a memory array (ARRAY-0 to 3) 44 connected to memory access controller 42.

In addition, SSUs 4A and 4B each include a system configuration control circuit (CNFG) 46 that sets the configuration of a system storage unit, a priority control circuit (PRIO) 48 that performs priority control of memory, an SSU-SVP 12, and a system console interface circuit (SCI) 12-1 through which SVP 12 is connected to each internal circuit (interface circuit 40, memory access controller 42, memory array 44, configuration control circuit 46, the priority control circuit 48, for example), the system console interface circuit (SCI) 12-1 being used to configure settings on the internal circuits.

Each memory access controller 42 includes a port control manager (PCM) 50 connected to interface circuit 40, an array controller (ARY) 52, which is connected to port control manager 50, for accessing a memory 54, and memory 54.

Memory array 44, which is connected to port control manager 50, includes an array controller (ARY) 56 for accessing a memory 58, and memory 58.

SSU-SVP 12 of FIG. 2 is connected to SCA 11 described with reference to FIG. 1, and is connected to LAN 5. SSU-SVP 12 has a version number management table 12A including HCPs, in which the version numbers of the operation system HCP and the standby system HCP of all the connected clusters and SSUs are stored. Furthermore, SSU-SVP 12 includes a hard disk for storing a file for storing the HCPs of the version numbers stored in version number management table 12A. The HCP is firmware that controls the hardware inside an SSU and performs resetting, setting, and the like of interface circuit 40, memory access controller 42, memory array 44, configuration control circuit 46, and priority control circuit 48.

In FIG. 2, the SSU includes four memory banks and five interface circuits, but is not limited to these.

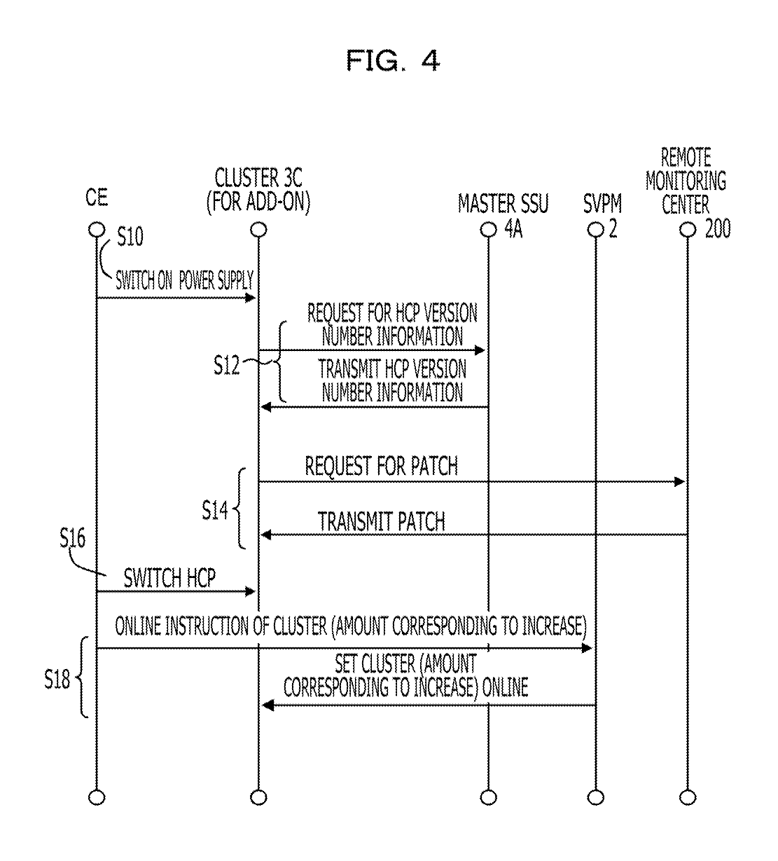

Add-on clusters to be described with reference to FIG. 4 and subsequent figures have substantially the same structure as that of the cluster illustrated in FIG. 2.

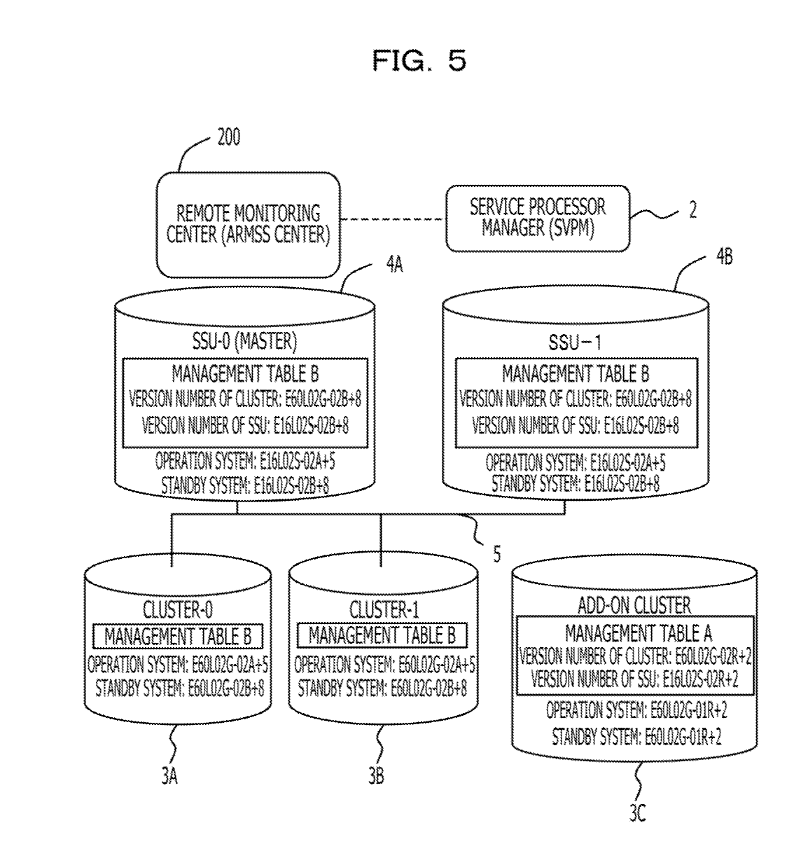

FIG. 4 is a sequence diagram of program updating according to a first embodiment of a multi-cluster system. FIGS. 5 to 9 are illustrations of the program updating sequence of FIG. 4.

A description is given below, with reference to FIG. 5 to FIG. 9, of a program updating process of an add-on cluster illustrated in FIG. 4.

(S10) FIG. 5 illustrates a state of HCP version numbers of a multi-cluster system before a cluster is added on. As illustrated in FIG. 5, it is assumed that a cluster 3C is to be newly added on to or incorporated in the multi-cluster system 1 that already includes a plurality of SSUs (SSU-0, SSU-1) 4A and 4B, and a plurality of clusters (cluster-0, cluster-1) 3A and 3B. With a CE operation, add-on cluster 3C is connected to LAN 5 and is also connected to SSUs 4A and 4B, and the power supply of add-on cluster 3C is switched on.

As illustrated in FIG. 5, the program version number of add-on cluster 3C is “E60L02G-01R+2” for the operation system and is “E60L02G-01R+2” for the standby system, and differs from the version number of existing clusters 3A and 3B and SSUs 4A and 4B (“E60L02G-02A+5” for the operation system and “E60L02G-02R+8” for the standby system). Consequently, in a state as is, add-on cluster 3C cannot be incorporated into multi-cluster system 1.

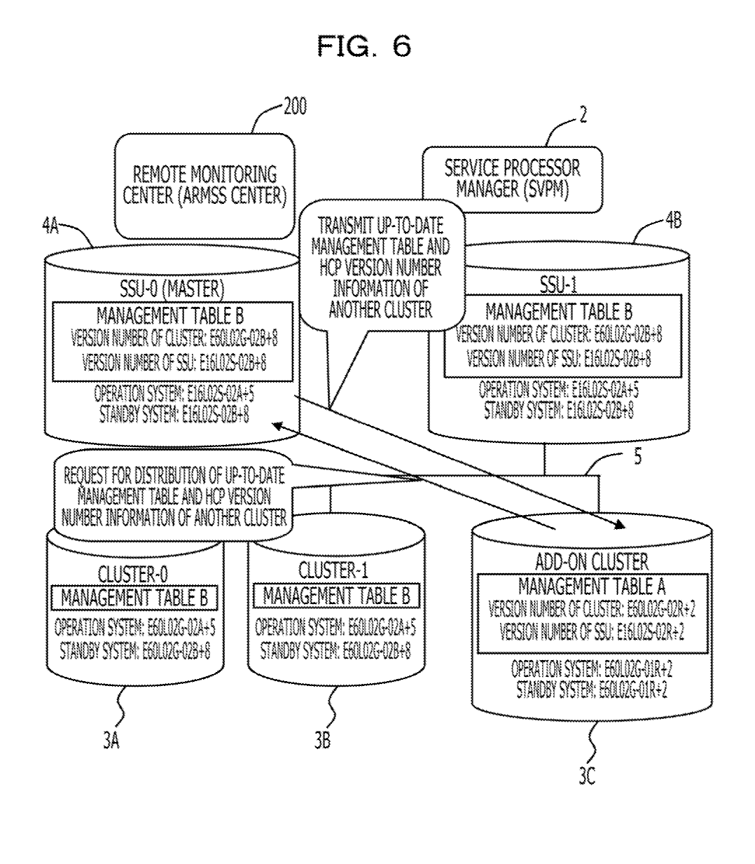

(S12) As illustrated in FIG. 6, in response to the power supply being switched on, SVP 9 of add-on cluster 3C requests SVP 12 of master SSU 4A, via LAN 5, for the distribution of the up-to-date management table (management table B, for example) and of the HCP version number information during operation of another cluster. SVP 12 of SSU 4A then receives a request for the distribution of the management table and the HCP version number information during operation of the other cluster, and in a substantially instant manner, distributes the management table and the HCP version number information during operation of the other cluster to cluster 3C.

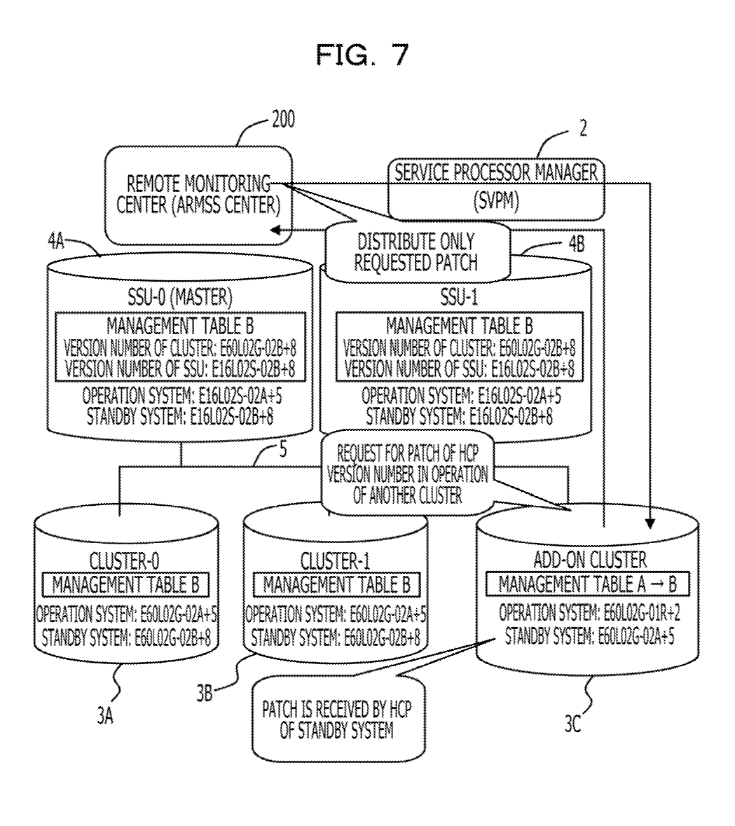

(S14) As illustrated in FIG. 7, add-on cluster 3C detects that the version number of management table A of add-on cluster 3C does not match the version number of the distributed management table B. In this case, add-on cluster 3C rewrites management table A to management table B, and requests remote monitoring center 200 for a patch of the received HCP version number information during operation in the other cluster via SVPM 2 so that the HCP version number of add-on cluster 3C matches that of the operating-system HCP of the other clusters 3A and 3B. Remote monitoring center 200 distributes the requested patch to add-on cluster 3C via SVPM 2 and LAN 5. Add-on cluster 3C updates the HCP of the standby system by using the received patch, and updates the HCP version number of the standby system of the management table. For example, the version number of the standby-system HCP is updated to “E60L02G-02A+5”, which matches the HCP version number during operation of the other cluster.

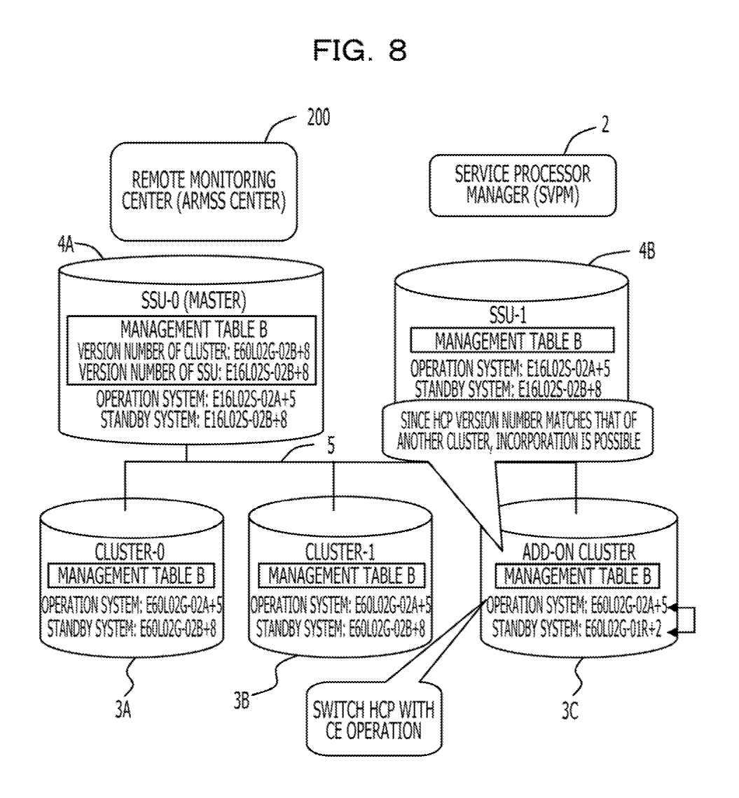

(S16) As illustrated in FIG. 8, with a CE operation, the standby-system HCP of add-on cluster 3C is switched to a operation system, and the version number of the HCP of the operation system is made to match the version number of the HCP during operation of the other clusters 3A and 3B.

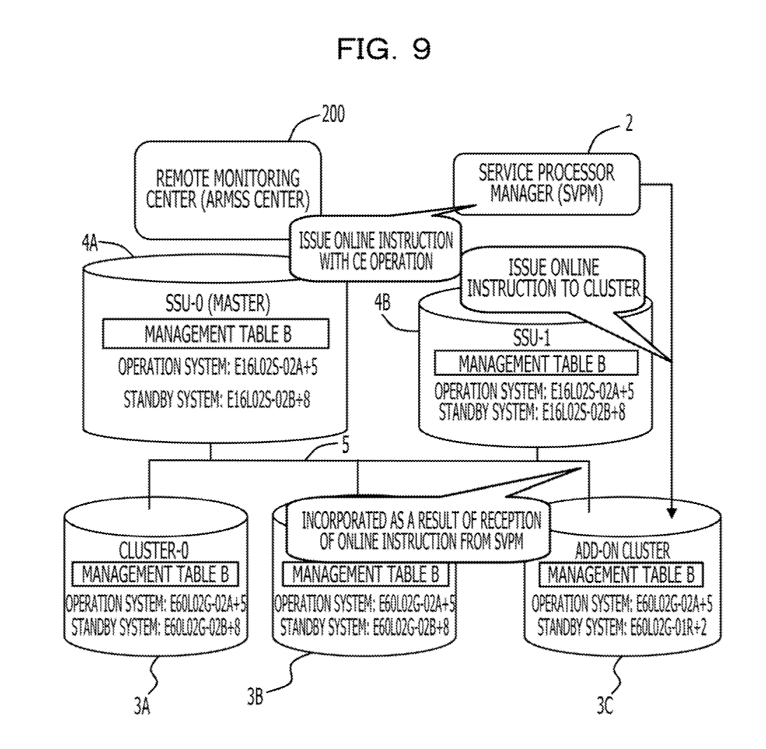

(S18) As illustrated in FIG. 9, with a CE operation, service processor manager 2 is instructed to set the add-on cluster 3C online. In this state, since the version number of the HCP of add-on cluster 3C matches the version number of the HCP of the other clusters 3A and 3B, an online instruction is issued to add-on cluster 3C from service processor manager 2, and add-on cluster 3C is incorporated into multi-cluster system 1.

As described above, in the present embodiment, add-on cluster 3C is provided with functions of receiving a patch from the remote monitoring center, switching between the HCPs, and being incorporated into the multi-cluster system. That is, in the present embodiment, add-on cluster 3C is provided with functions (a program, for example) of requesting the SSU-SVP for the HCP version number in response to the power supply being switched on, receiving a version number management table, and requesting the remote monitoring center for the patch. Therefore, the add-on cluster can be updated without halting the CE operation while waiting for the version number management table during periodic communication, and the add-on cluster can be incorporated into the multi-cluster system. As a result, it is possible to shorten the CE operation time.

Even when a new cluster whose operation has been halted for a long period of time for the convenience of the user, and is to be incorporated into the multi-cluster system once more, in the present embodiment, the update of the version number of the HCP can be performed instantly, so that the HCP version number of the new cluster to be incorporated matches those of the other clusters. Consequently, such a new cluster can be easily incorporated into the multi-cluster system without providing an HCP of the matching version number as that of the system that is being operated.

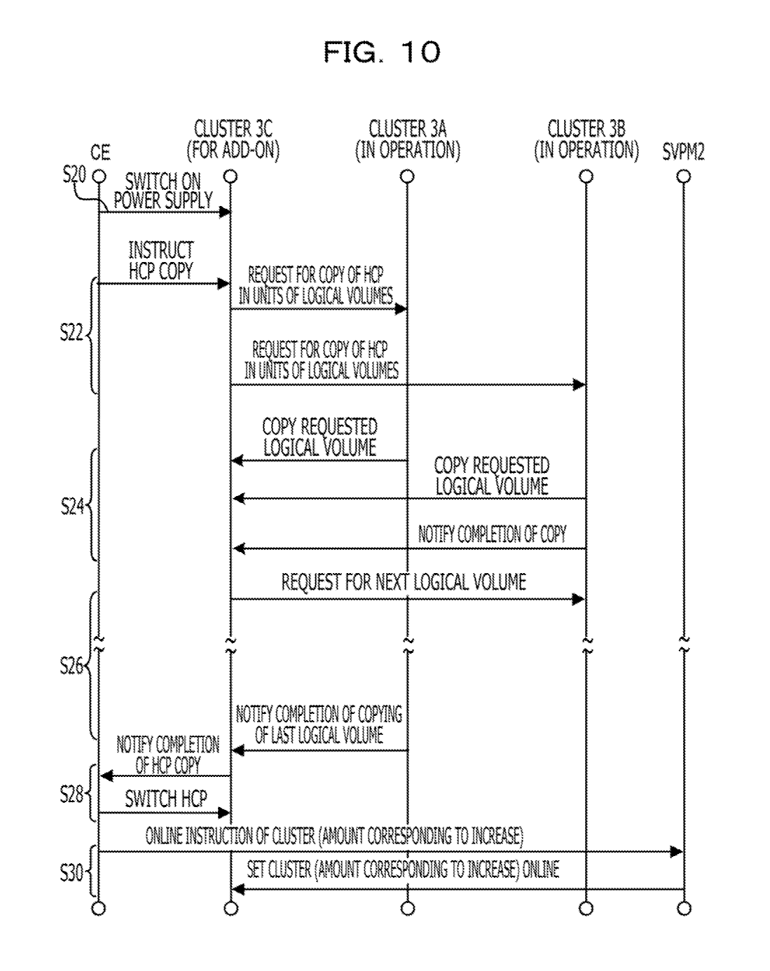

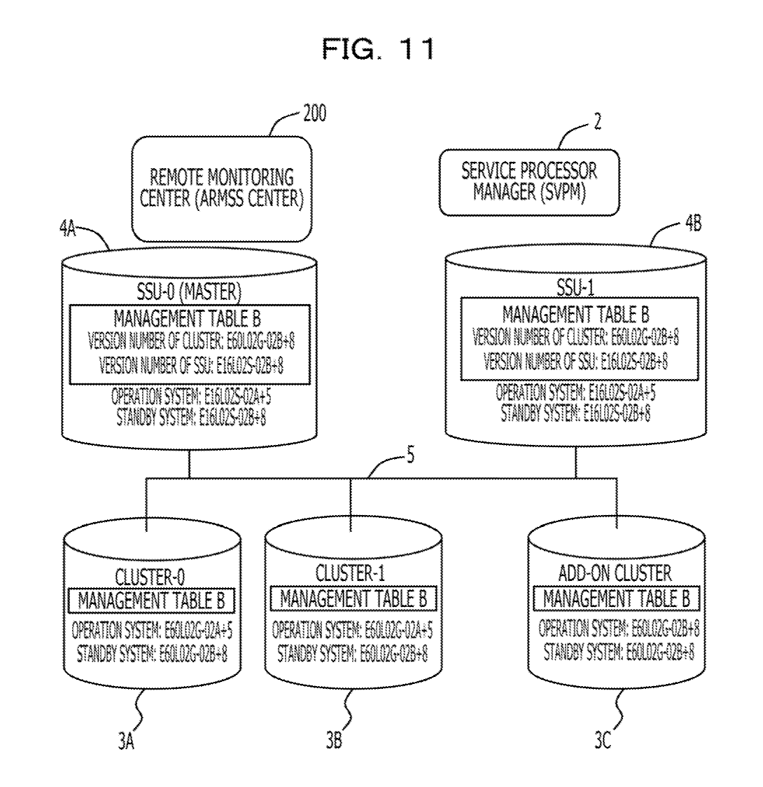

FIG. 10 is a sequence diagram of program updating according to a second embodiment of a multi-cluster system. FIGS. 11 to 21 illustrate the program updating sequence of FIG. 10.

A description is given below, with reference to FIGS. 11 to 21, of a program updating process of an add-on cluster illustrated in FIG. 10.

(S20) FIG. 11 illustrates the state of HCP version numbers of the multi-cluster system before an add-on cluster is incorporated into the multi-cluster system. As illustrated in FIG. 11, multi-cluster system 1 includes a plurality of SSUs (SSU-0, SSU-1, for example) 4A and 4B and a plurality of clusters (e.g., cluster-0, cluster-1) 3A and 3B that incorporates an add-on cluster 3C. With a CE operation, add-on cluster 3C is connected to LAN 5 and is also connected to SSUs 4A and 4B, and the power supply of add-on cluster 3C is switched on.

As illustrated in FIG. 11, the HCP version number of add-on cluster 3C is “E60L02G-02B+8” for the operation system and is “E60L02G-02B+8” for the standby system. Thus, the up-to-date HCP version number of add-on cluster 3C differs from the version numbers (“E60L02G-02A+5” for the operation system, and “E60L02G-02R+8” for the standby system) of existing clusters 3A and 3B and SSUs 4A and 4B. Therefore, in a state as is, add-on cluster 3C cannot be incorporated into the multi-cluster system.

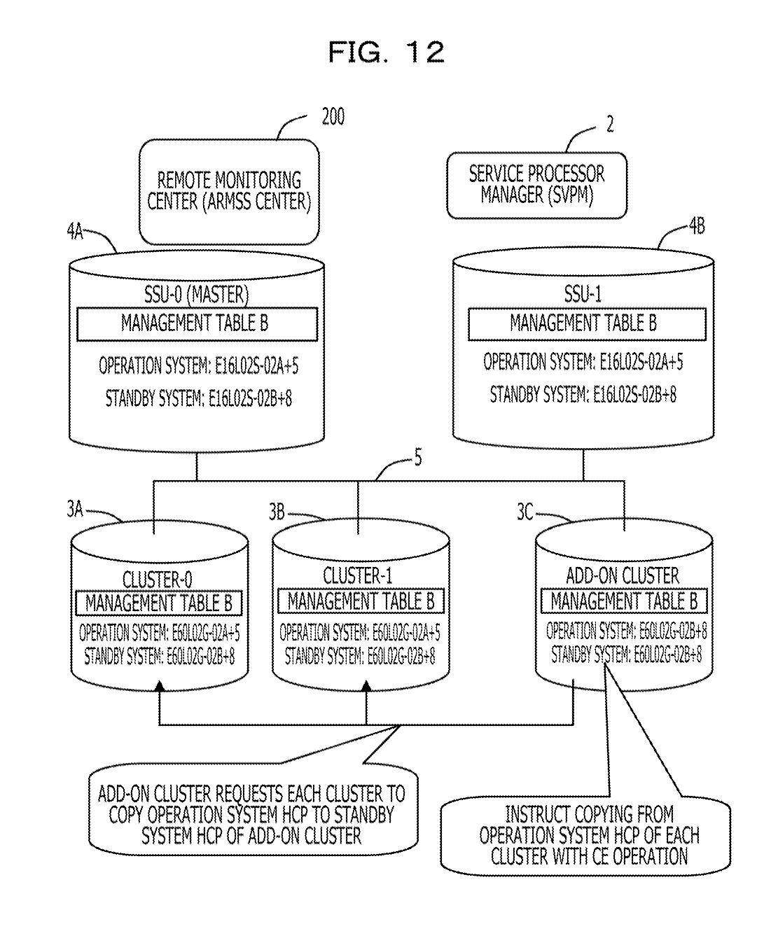

(S22) With a CE operation, an HCP copy instruction is issued from add-on cluster 3C to clusters 3A and 3B in an operation state. That is, as illustrated in FIG. 12, add-on cluster 3C is instructed to copy the HCP. Add-on cluster 3C requests via LAN 5, as instructed by the CE request, that each of clusters 3A and 3B copy the operation system HCP of the add-on cluster 3C as the standby-system HCP of each of clusters 3A and 3B.

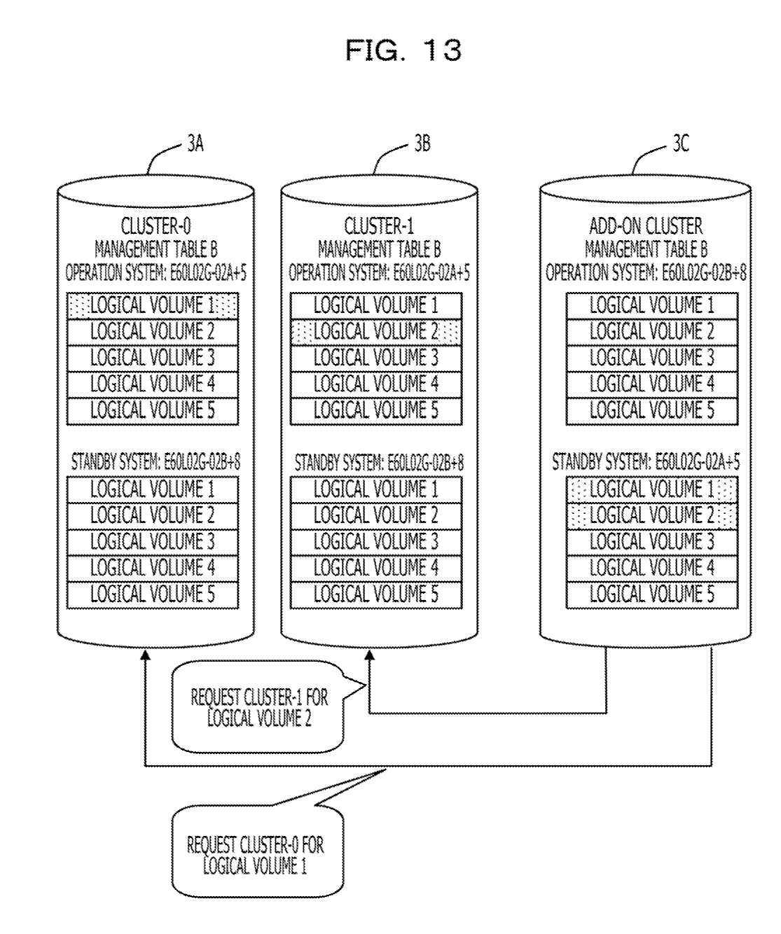

As illustrated in FIG. 13, add-on cluster 3C divides the data area of the HCP into plural portions or areas (hereinafter referred to as “logical volumes”) and requests clusters 3A and 3B for data that exists in separate portions/areas in each of these clusters 3A, 3B. For example, the data area of the HCP of clusters 3A and 3B is illustrated as being divided into five portions.

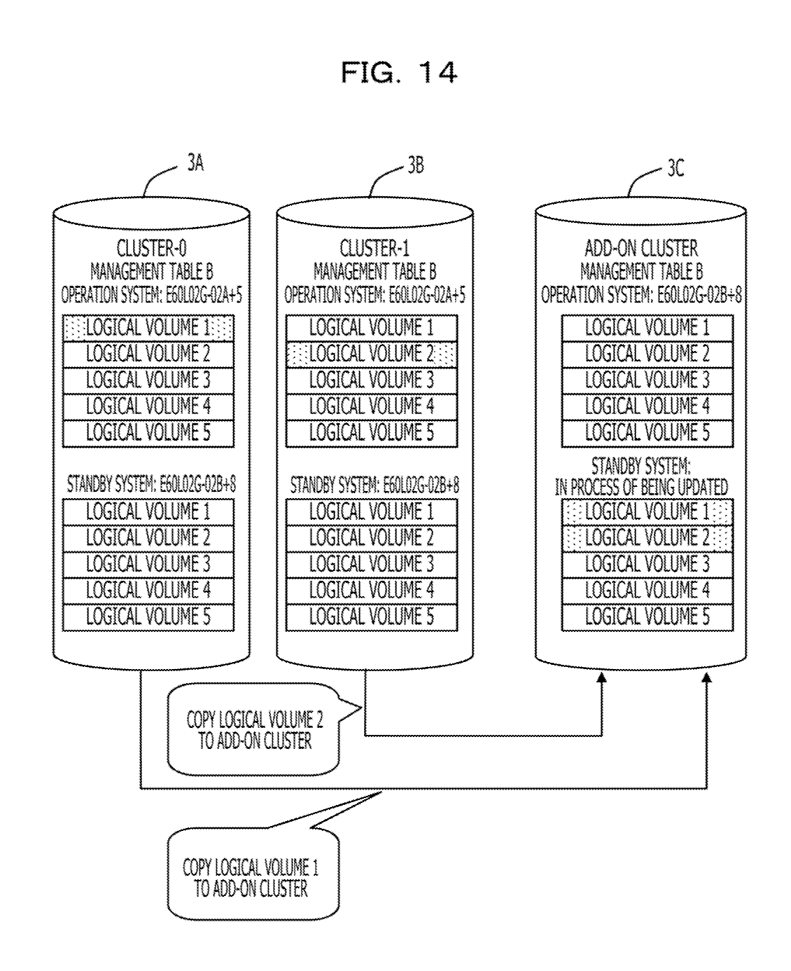

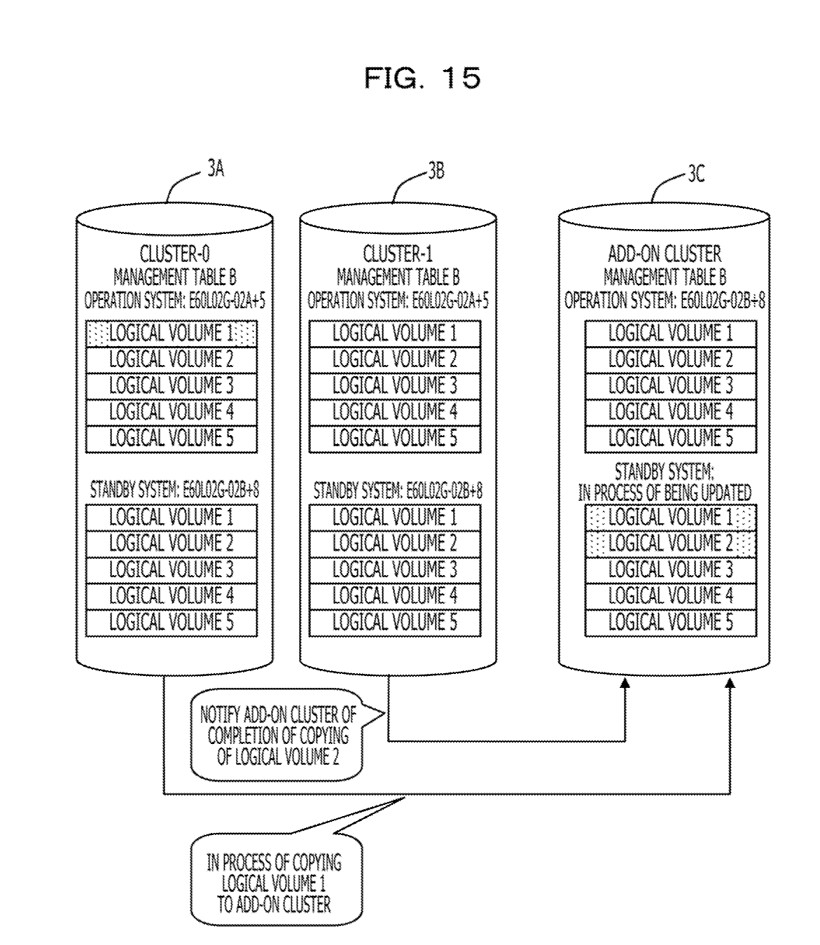

(S24) The logical volume of the HCP is copied from each of clusters 3A and 3B to add-on cluster 3C. For example, as illustrated in FIG. 14, clusters 3A and 3B receive a request of the HCP logical volume copies, via the LAN 5, in which the HCP data corresponding to the requested area is copied to the standby-system HCP of add-on cluster 3C. Then, as illustrated in FIG. 15, add-on cluster 3C is notified of the completion of the HCP logical volume copy from clusters 3A and 3B. That is, clusters 3A and 3B, in which the requested copy of the logical volume has been completed, notifies add-on cluster 3C that the HCP logical volume copies from clusters 3A and 3B has been completed.

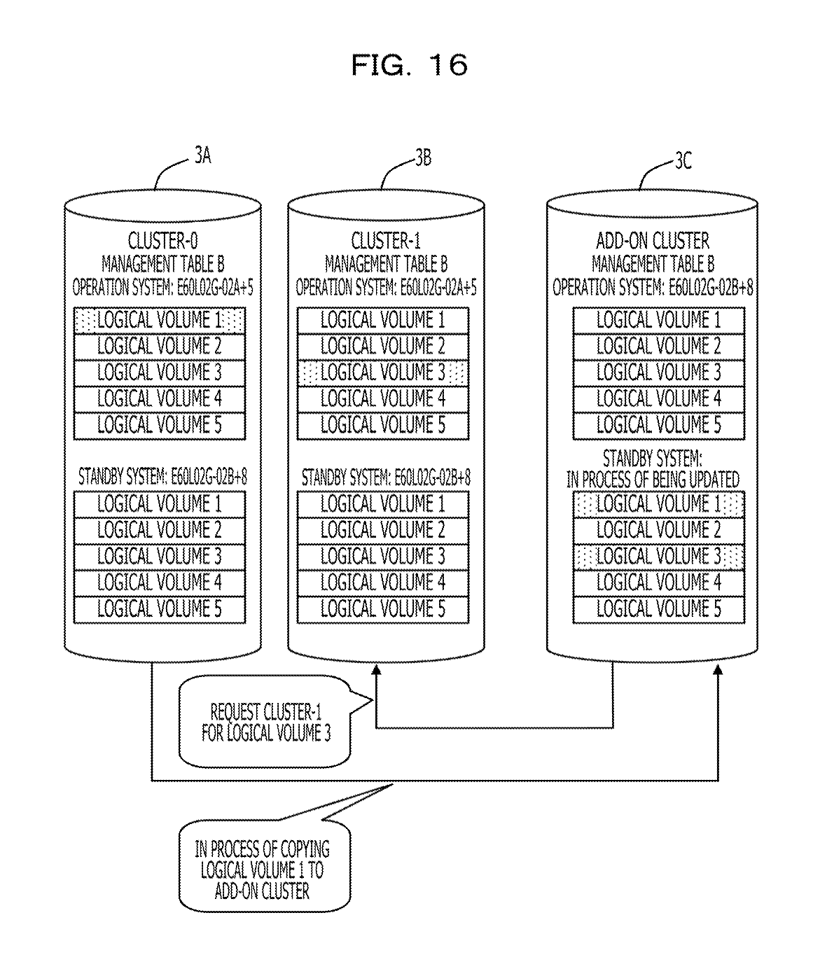

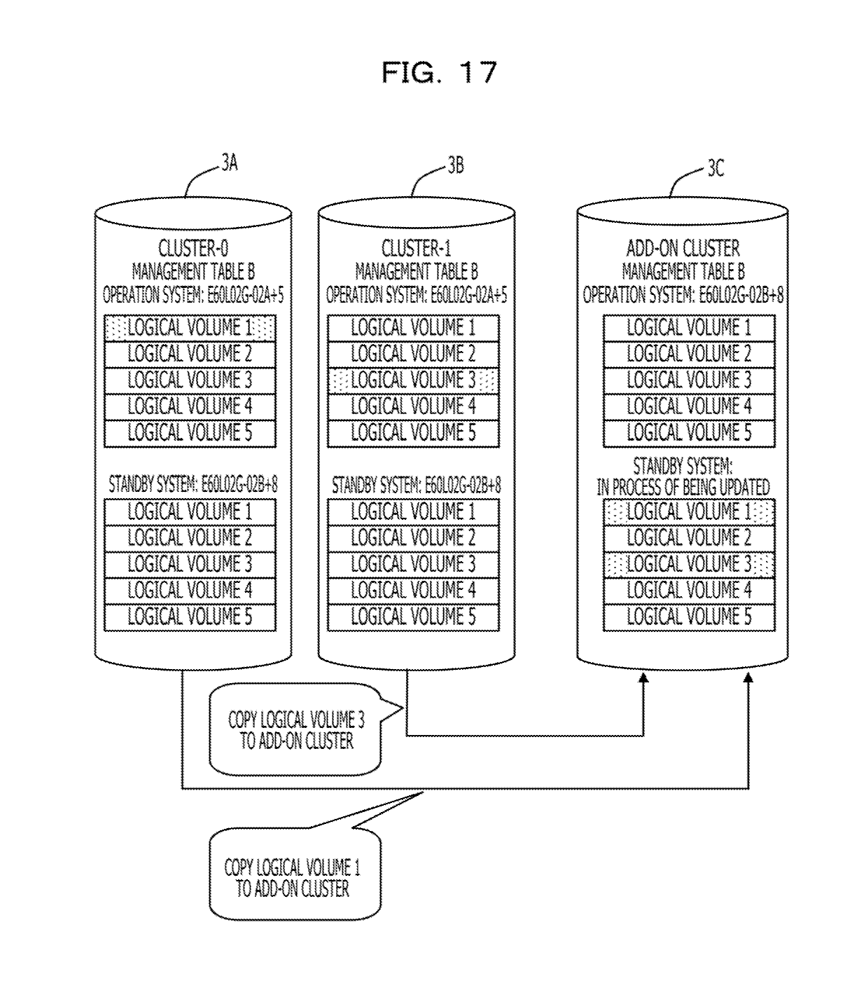

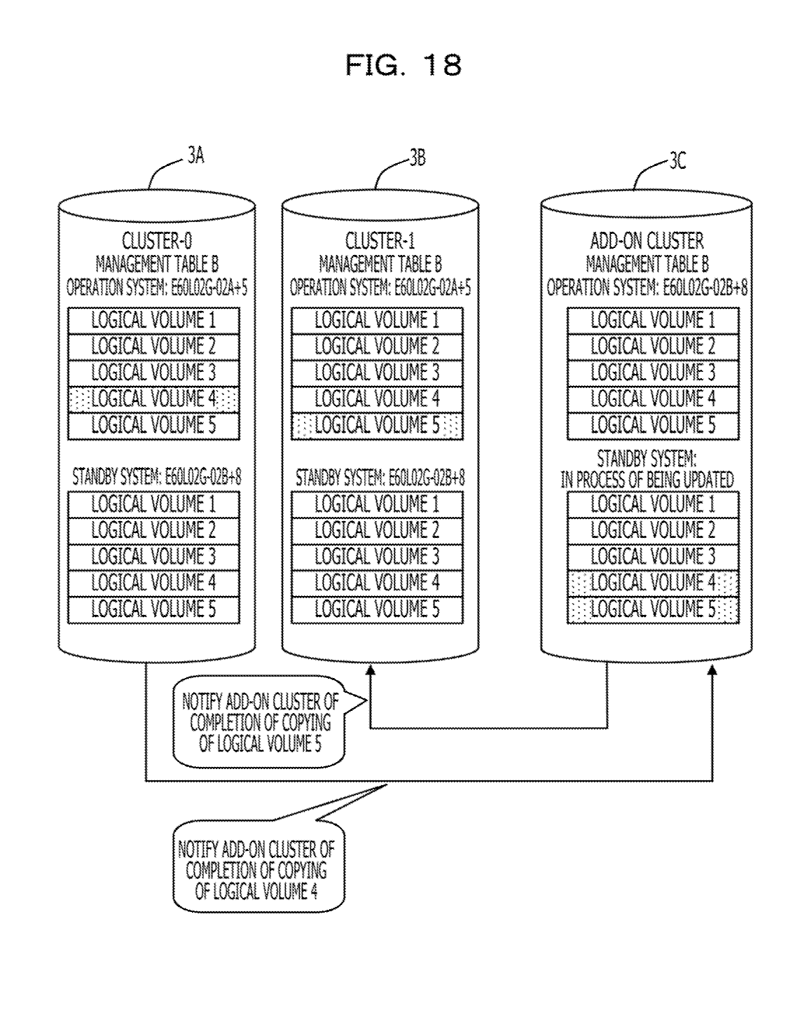

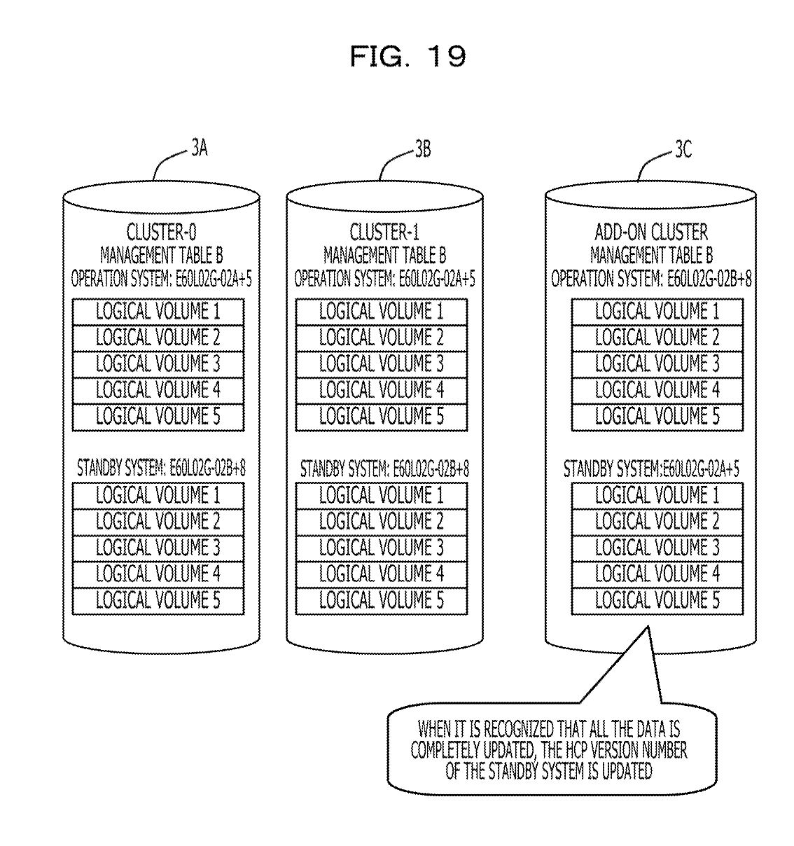

(S26) A request for the next logical volume is made from add-on cluster 3C. That is, as illustrated in FIG. 16, add-on cluster 3C requests cluster 3B, having been notified of the completion of the previous HCP logical volume copy via the LAN 5, for the next logical volume. As illustrated in FIG. 17, cluster 3B receives the request for the next logical volume and copies the logical volume of the requested area to the standby-system HCP of the add-on cluster 3C. Then, as illustrated in FIG. 18, add-on cluster 3C repeats the operations of S24 and S26 (illustrated in FIG. 10) until the copy of all the logical volumes is completed. Then, as illustrated in FIG. 19, when add-on cluster 3C recognizes that the copy of all the logical volumes has been completed, and stops the logical volume request. Furthermore, add-on cluster 3C, having completed the HCP copy to the standby system of add-on cluster 3C makes the standby-system HCP version number possessed by itself match the operating-system HCP version numbers of the other clusters that have performed the copy. The end of the operation for making the HCP version numbers match each other completes the HCP copy.

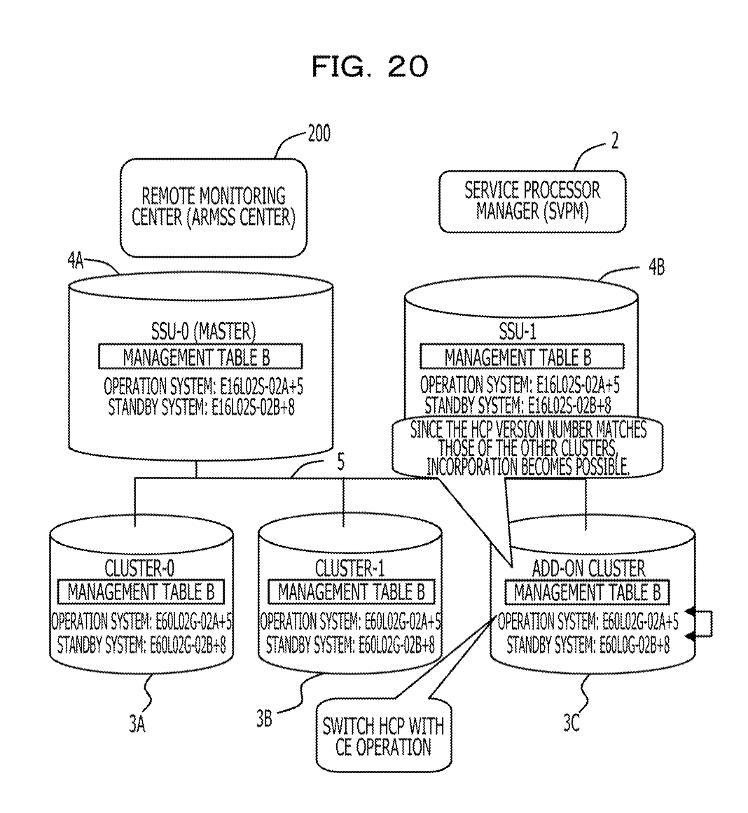

(S28) As illustrated in FIG. 20, add-on cluster 3C notifies the CE of the completion of the copy. Then, with a CE operation, the standby-system HCP of the add-on cluster 3C is switched to an operation system HCP of the add-on cluster 3C, and the HCP version number of the operation system of add-on cluster 3C is made to match the version number of the HCPs during operation of the other clusters 3A and 3B.

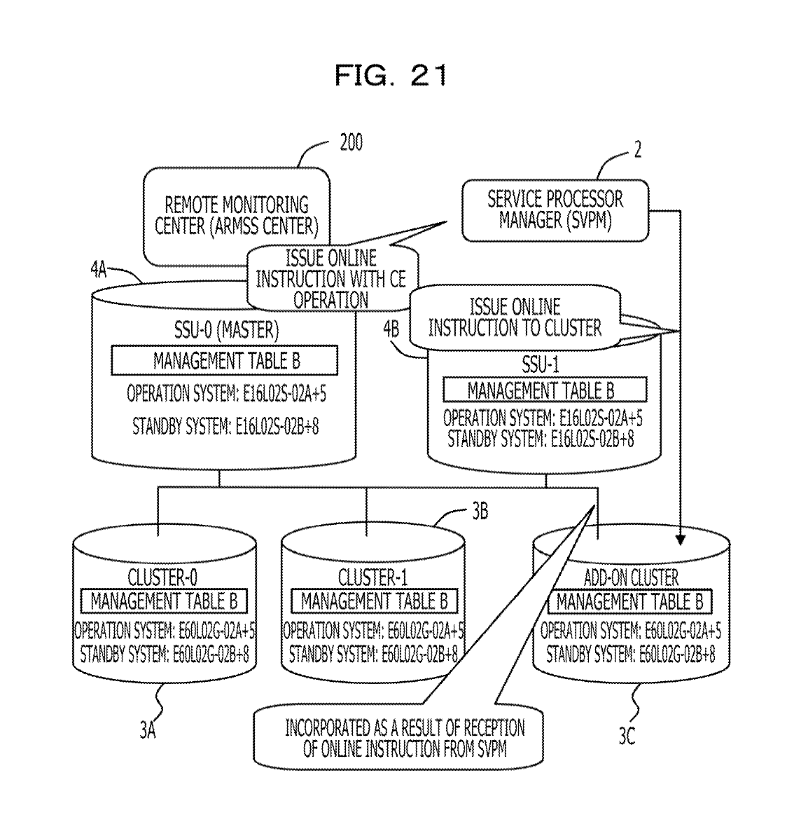

(S30) As illustrated in FIG. 21, with a CE operation, service processor manager 2 is instructed to set the add-on cluster 3C online. Since the HCP version number of both the operation system and the standby system of the add-on cluster 3C matches the HCP version number of the other clusters 3A and 3B, an online instruction is issued from service processor manager 2 to add-on cluster 3C, and add-on cluster 3C is incorporated into multi-cluster system 1.

In the second embodiment, add-on cluster 3C is provided with functions (a program, for example) of making a request for copying an HCP from an add-on cluster to a plurality of clusters during operation, switching between HCPs, and being incorporated into the multi-cluster system. Thus, the add-on cluster can be updated without halting the CE operation while waiting for receiving a version number management table from master SSU 4A to be received, and can be incorporated into the multi-cluster system. Consequently, it is possible to shorten the CE operation time.

In the second embodiment, when the HCP version number of the cluster that is newly incorporated is the up-to-date HCP version number, there is provided a mechanism for downgrading this up-to-date HCP version number by copying an HCP version number from an in-operation cluster. For this reason, even if the HCP version number of the cluster that is being operated is an old version number, because the HCP of the add-on cluster can be made to match that of the cluster during operation, the cluster can be incorporated into the multi-cluster system.

Furthermore, even if the amount of the HCP data is large, divided logical modules are copied from a plurality of clusters, and a request for the next logical volume is made to the cluster for which the copy is completed without waiting for the completion of copy of the other clusters. Consequently, it is possible to distribute the load of the requested clusters, and it is possible to copy the cluster at high speed. For this reason, the influence on an operation state can be minimized, and the add-on cluster can be incorporated into the multi-cluster system.

In the above-described embodiments, the program updating of the add-on cluster has been described using an example of an HCP. Alternatively, the program updating of the add-on cluster can be applied to other firmware programs and application programs. Furthermore, the multi-cluster system has been described using two clusters and two system storage units. Alternatively, the multi-cluster system may have three or more clusters, and the number of system storage units may be one or more. In addition, the configuration of clusters and system storage units is not limited to that of the described embodiments.

In addition, the program updating of the add-on cluster has been described using a network in which a plurality of clusters and a plurality of system storage units are individually connected to one another. However, they may be connected using a common network or a connection may be made between clusters.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. A multi-cluster system comprising:
a plurality of clusters that execute a program;
the plurality of clusters are configured to receive a patch from a monitoring center to update the program;
a system storage unit that is connected to the plurality of clusters via a first network,
and
an add-on cluster to be added on to the multi-cluster system is connected to the first network, the add-on cluster receives, from the system storage unit, a version number management table and a program version number of an in-operation program in the plurality of clusters, requests the monitoring center to distribute a patch of the version number of the in-operation program in the plurality of clusters, receives the requested patch and updates the program that has been installed into the add-on cluster.

2. The multi-cluster system according to claim 1,
wherein each of the plurality of clusters including the add-on cluster include a CPU block, and a service processor that controls hardware of the CPU block, and
wherein the program is a hardware control program for controlling the hardware.

3. The multi-cluster system according to claim 2, further comprising:
a service processor manager that is connected via a second network to the service processors of each of the plurality of clusters including the add-on cluster,
wherein the service processor manager receives the patch from the monitoring center, and updates the program of the plurality of clusters via the second network.

4. The multi-cluster system according to claim 3,
wherein the service processor manager updates the program of the add-on cluster and thereafter incorporates the add-on cluster into the multi-cluster system in response to an external instruction.

5. The multi-cluster system according to claim 1,
wherein the plurality of clusters including the add-on cluster have an in-operation program and an in-standby program, and
wherein the add-on cluster updates the in-standby program by using the patch received from the monitoring center and thereafter switches the in-standby program to an in-operation program.

6. A multi-cluster system comprising:
a plurality of clusters that execute a program;
a system storage unit that is connected to the plurality of clusters via a first network; and
an add-on cluster in which a program is installed,
wherein, when the add-on cluster is connected to the first network and requests, from the plurality of clusters via the first network, that programs of version numbers of in-operation programs in the plurality of clusters are divided and transmitted, receives the requested program, and updates the program version number of the add-on cluster.

7. The multi-cluster system according to claim 6,
wherein each of the plurality of clusters and the add-on cluster include a CPU block, and a service processor that controls hardware of the CPU block, and
wherein the program is a hardware control program for controlling the hardware.

8. The multi-cluster system according to claim 6,
wherein each of the plurality of clusters and the add-on cluster include an in-operation program and an in-standby program, and
wherein the add-on cluster updates the in-standby program and thereafter switches the in-standby program to an in-operation program.

9. The multi-cluster system according to claim 6, further comprising:
a service processor manager that is connected via a second network to each of the plurality of clusters, the add-on cluster, and the system storage unit, and that monitors a configurational state of the multi-cluster system,
wherein the service processor manager updates a program of the add-on cluster and thereafter incorporates the add-on cluster into the multi-cluster system in response to an external instruction.

10. A method of updating a program in a multi-cluster system including a plurality of clusters that execute a program, a system storage unit that is connected to the plurality of clusters, and a first network for connecting the plurality of clusters with the system storage unit, the method comprising:
receiving a patch of the program from a monitoring center and updating programs of the plurality of clusters;
requesting, by an add-on cluster, the system storage unit to transmit information indicating version numbers of in-operation programs in the plurality of clusters when the add-on cluster in which a program has been installed is connected to the network, and receiving, from the system storage unit, the information indicating the version numbers of the in-operation programs;
requesting, by the add-on cluster, the monitoring center to distribute a patch of the program of the received version number; and
receiving, by the add-on cluster, the requested program patch, and
updating the program of the add-on cluster.

11. The method of updating a program in a multi-cluster system according to claim 10, further comprising:
connecting, when the program is to be updated, the add-on cluster to the monitoring center via a service processor manager that is connected to service processors of the plurality of clusters and the add-on cluster through a second network; and
receiving, by the add-on cluster, a patch of the program from the monitoring center via the second network, and updating the program of the add-on cluster.

12. The method of updating a program in a multi-cluster system according to claim 10, further comprising:
updating, by the plurality of clusters each having an in-operation program and an in-standby program, the in-standby program by using the patch received from the monitoring center; and
updating, by the add-on cluster, the in-standby program, and thereafter switching the in-standby program to an in-operation program.

13. The method of updating a program in a multi-cluster system according to claim 10, further comprising:
updating, by the service processor manager, a program of the add-on cluster, and thereafter incorporating the add-on cluster into the system in response to an external instruction.

14. A method of updating a program in a multi-cluster system including a plurality of clusters that execute a program, a system storage unit that is connected to the plurality of clusters, a first network for connecting the plurality of clusters with the system storage unit, and a second network for connecting the plurality of clusters with the system storage unit, the method comprising:
requesting, by an add-on cluster via the second network, from the plurality of clusters that programs of in-operation program version numbers of the plurality of clusters are divided and transmitted when the add-on cluster having a program installed therein is connected to the second network; and
receiving, by the add-on cluster, the requested programs, and updating the programs and the version number of the programs installed in the add-on cluster.

15. The method of updating a program in a multi-cluster system according to claim 14, further comprising:
updating, by the add-on cluster, the in-standby program of the cluster having an in-operation program and an in-standby program, and the program version number, and thereafter switching the in-standby program and the program version number to an in-operation program and a version number of the in-operation program.

16. The method of updating a program in a multi-cluster system according to claim 14, further comprising:
updating, by a service processor manager that monitors a configurational state of the system, the program of the add-on cluster and a version number of the program, and thereafter setting the add-on cluster online so as to incorporate the add-on cluster into the system in response to an external instruction.
